(19) United States
(12) Patent Application Publication
(10) Pub. No.: US 2005/0229390 A1
(43) Pub. Date: Oct. 20, 2005

(54) Method and system for obtaining a bundle of wires containing a given number of wires and, more particularly, a bundle of crimped wires

(75) Inventors: Marino Romagnoli, San Lazzaro Di Savena (IT); Raffaele Nadalini, Casalecchio Di Reno (IT)

Correspondence Address: THE FIRM OF KARL F ROSS, 5676 RIVERDALE AVENUE, PO BOX 900, RIVERDALE (BRONX), NY, 10471-0900, US

(73) Assignee: UNIMAC S.R.L.

(21) Appl. No.: 11/107,998

(22) Filed: Apr. 14, 2005

(30) Foreign Application Priority Data
Apr. 20, 2004 (IT) BO2004A000226

(51) Int. Cl. B23P 19/00

(52) U.S. Cl. 29/748; 29/755

(57) ABSTRACT

A method for obtaining a bundle of wires containing a desired number of wires comprises: a)—winding the wire (F) in a configuration having the form of a first spiral (E1); b)—winding the wire (F) in a configuration having the form of an additional spiral (E2) arranged alongside the preceding spiral (E1); c)—performing the operation b) one or more times until a helical bundle (En) is obtained. The final bundle (6) of wires is obtained by extension of the helical bundle (En) of individual spirals (E1, E2, E3, etc.) formed in succession. A system for implementing the said method comprises a drum (201) having, formed on its casing, a multiple-turn helical groove (202) provided with retaining means (203a, 203b) intended to retain the wire (F) or the bunch of wires (F50) in the vicinity of at least one end (202a, 202b) of said helical groove (202).

### FIELD OF THE INVENTION

The present invention falls within the category of methods and systems for obtaining a bundle of wires containing a given number of wires and, more particularly, a bundle of crimped wires.

### BACKGROUND OF THE INVENTION

Prior Art 1

At present (see FIG. 1) a first known system for obtaining a bundle of wires and, more particularly, a bundle of crimped wires comprises, in schematic form, a reel-holder unit 110, a wire-feeding/crimping unit 120 and a drum-holder unit 130.

With this system, from the reel-holder unit 110, which is shown here for example with four reels, B1, B2, B3, B4, four continuous straight wires F1, F2, F3, F4 are unwound and pass through the wire-crimping unit 120 in order to obtain, at the outlet, a bunch F140 comprising four crimped wires, said bunch F140 being then wound inside a circular channel 131 of a drum 132.

With this system, in brief, a bunch F140 of four crimped wires is arranged inside the channel 131 with each complete revolution of the drum 132, so that a predetermined number of revolutions of the drum 132 is performed until a desired number of wires is obtained inside the same channel 131, for example 50 complete revolutions so as to obtain 200 wires (50 turns×4 wires per turn) and, after this, a radial cut 150 is performed at the initial point of the circular hank thus obtained, so as to obtain a bundle of crimped wires having a length equal to the extension of the said cut circular hank, i.e. a length defined and limited by the extent of the diameter D100 of the circular channel, i.e. length L=D100×3.14.

With this system it is therefore possible to obtain a bundle of crimped wires having a desired number of wires, in the specific case a multiple of four, having used a bunch with four wires and four reels, but this system has the drawback of obtaining a wire bundle segment having a length which is limited or restricted and fairly short.

Prior Art 2

Also at present (see FIG. 2), a second known system for obtaining a reel containing a bundle of crimped wires comprises, schematically, a reel-holder unit 210, a wire-crimping unit 220 and a drum-holder unit 230.

With this system, in order to obtain a bundle of wires containing 150-250 wires, the reel-holder unit 210 must have 150-250 reels of continuous wire, B1, B2, etc. (only some of them have been shown) in order to convey into the crimping unit 220 a plurality of 150-250 wires, F1, F2, etc. and obtain, at the outlet of said unit 220, a bundle F240 of 150-250 crimped wires, which is then wound onto a core 231 of a drum 232.

With this system it is possible to obtain on the drum 232 a bundle of wires with a length greater than that possible with the above system, but this system has the drawback of requiring a large-size reel holder unit 210 able to hold 150-250 reels, a wire distribution/conveying system for 150-250 wires, a large number of reels and a large-size crimping unit 220 able to handle 150-250 wires simultaneously.

Moreover, with this known system, format-changing depending on the type of individual wires is very complex since it is required to replace the 150-250 reels and since it is also necessary to insert each of the 150-250 wires along the unwinding and processing path so as to reach finally the storage drum 232.

### OBJECT OF THE INVENTION

The object of the present invention is that of solving the abovementioned drawbacks.

### SUMMARY OF THE INVENTION

The invention, which is characterized by the claims, solves the problem of creating a method for obtaining a bundle of wires containing a desired number of wires, in particular a bundle of wires containing a desired number of crimped wires, which envisages using a wire or a bunch of wires, said method comprising the following operations: a)—winding the wire or the bunch in a configuration having the form of a first multiple-turn spiral having a leading end and a terminal end; b)—winding the wire or the bunch in a configuration having the form of an additional multiple-turn spiral arranged alongside the preceding spiral with the leading end of said additional spiral arranged alongside the terminal end of the preceding spiral and with the terminal end of said additional spiral arranged alongside the leading end of the preceding spiral; c)—performing the operation b) one or more times until a helical bundle containing a desired number of individual successive multiple-turn spirals arranged alongside each other is obtained, the individual spirals having first ends arranged alongside each other and second opposite ends arranged alongside each other; and obtaining the final bundle of wires containing a desired number of wires by extension of the helical bundle of individual spirals formed in succession, said final bundle having a first end consisting of the group of first ends of the individual spirals and an opposite second end consisting of the group of second opposite ends of the same individual spirals.

The invention, which is characterized by the claims, also solves the problem of creating a system for implementing the abovementioned method, said system being characterized in that it comprises a drum having, formed on its casing, a helical groove with multiple turns comprising a first end and a second end; said helical groove having a width such as to contain a plurality of wires or a plurality of bunches; there being envisaged retaining means for retaining the wire or bunch in the vicinity of at least one end of said helical groove.

The abovementioned drawbacks are overcome by use of the method and system according to the present invention.

### BRIEF DESCRIPTION OF THE DRAWINGS

Further characteristic features and advantages of the present invention will emerge more clearly from the description which follows of a preferred practical embodiment thereof, provided here purely by way of a non-limiting example, with reference to the figures of the accompanying drawings in which:

FIG. 1 shows a first embodiment of the prior art;

FIG. 2 shows a second embodiment of the prior art;

FIGS. 3, 3A, 3B and 3C show a first embodiment of the method according to the present invention;

FIGS. 4, 4A, 4B and 4C show a second embodiment of the method according to the present invention;

FIG. 5 shows a first embodiment of the system according to the present invention;

FIG. 6 shows a second embodiment of the system according to the present invention;

FIGS. 7-7A, 8-8A, 9-9A, 10-10A, 11-11A, 12-12A, 13-13A, 14-14A, 15-15A show schematically the system according to the present invention in various successive operative configurations;

FIG. 16 shows an operating detail.

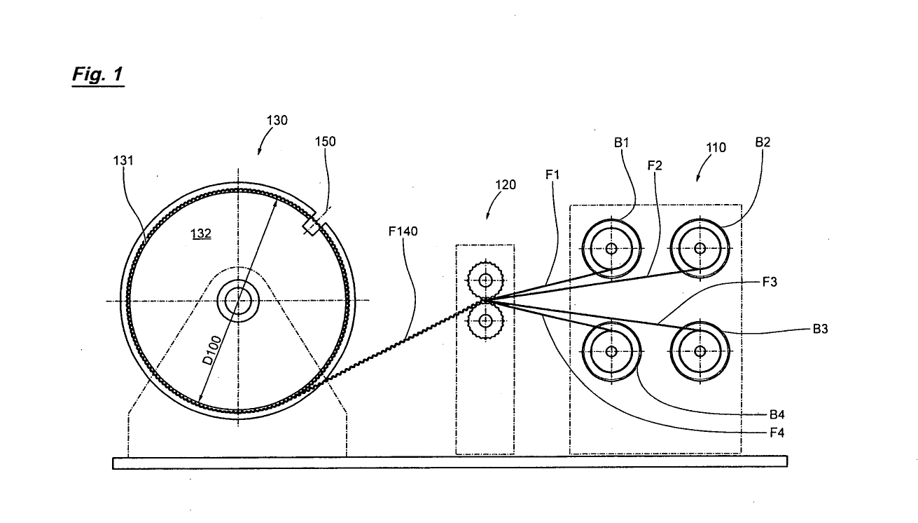

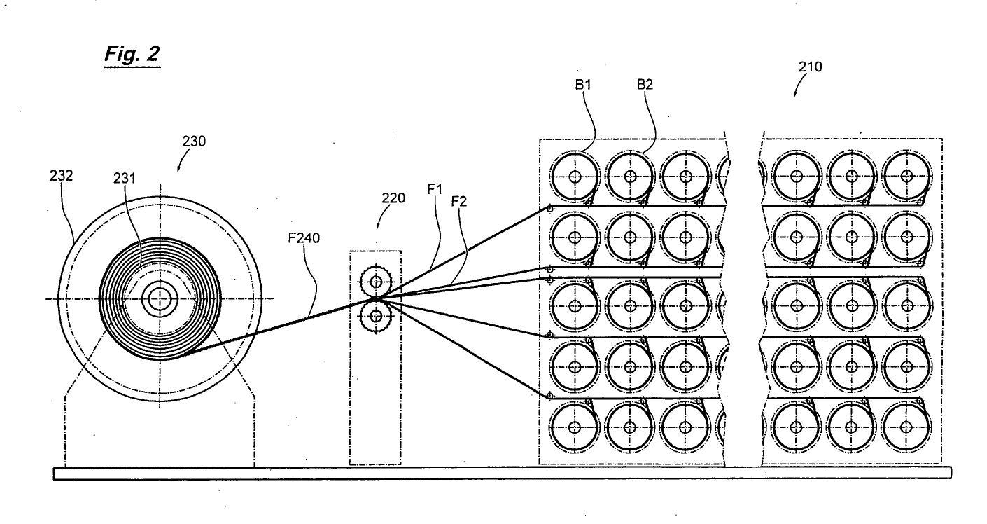

### SPECIFIC DESCRIPTION

Description of the First Embodiment of the Method—Feeding of a Single Wire

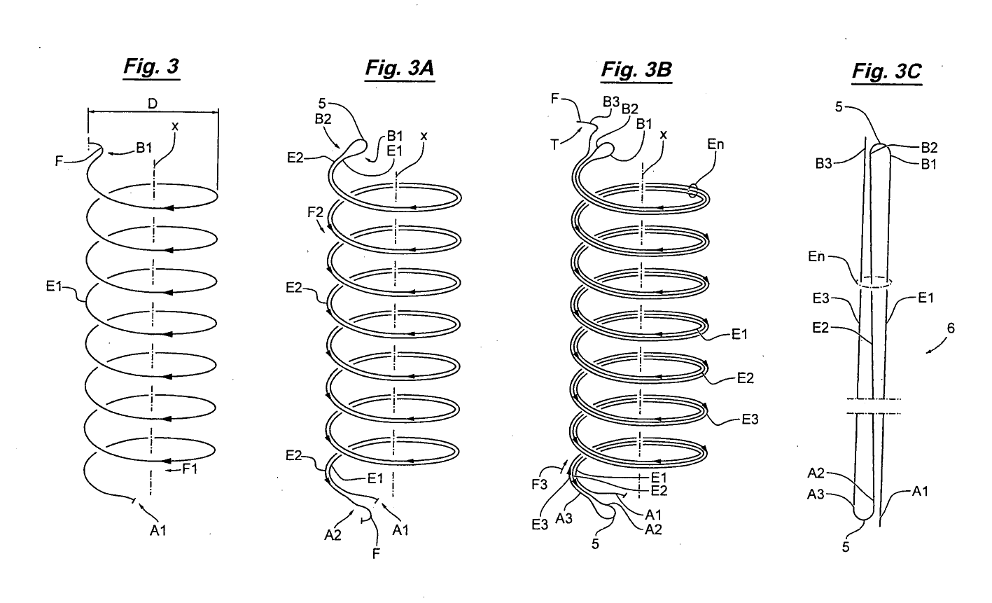

With reference to FIG. 3, according to a first embodiment, the method for obtaining a bundle of wires containing a desired number of wires, in particular a bundle of wires containing a desired number of crimped wires, starting from a wire F fed continuously, envisages various operating steps.

Initially (see FIG. 3) a first operation a) is performed, said operation involving winding the wire F in a configuration having the form of a first multiple-turn spiral E1, following a winding path defined by the arrow F1, said spiral E1 having a leading end A1 and a terminal end B1.

Then (see FIG. 3A) a second operation b) is performed, said operation involving winding the same continuously fed wire F in a configuration having the form of an additional multiple-turn spiral E2 arranged alongside the preceding spiral E1, following a winding path defined by the arrow F2 having a direction opposite to the direction F1 of the preceding winding E1, said additional winding E2 having the leading end B2 arranged alongside the terminal end B1 of the preceding spiral E1 and the terminal end A2 arranged alongside the leading end A1 of the preceding spiral E1.

Depending on the number of wires which the final bundle must contain, as can be better understood below (see FIG. 3B), a third operation c) is performed, said operation involving carrying out operation b) one or more times, a first repetition involving winding of the same continuously fed wire F in a configuration having the form of an additional multiple-turn spiral E3 arranged alongside the preceding spirals E1, E2, following a winding path defined by the arrow F3 having a direction opposite to the direction F2 of the preceding winding E2, said additional spiral E3 having the leading end A3 arranged alongside the terminal end A2 of the preceding spiral E2 and the terminal end B3 arranged alongside the leading end B2 of the preceding spiral E2.

In this connection, preferably, when formation of a spiral following that of a preceding spiral is carried out, an eyelet 5 is formed with the wire portion F which constitutes the reversal of the winding path and, more particularly, an eyelet 5 is formed between a terminal end of a spiral and a leading end of the following spiral B1-5-B2, A2-5-A3.

With this operating method (see FIG. 3B again), repeating the operation b) several times, it is possible to obtain a group En of spirals E1, E2, E3, etc. arranged alongside each other, the individual spirals E1, E2, E3, etc., having first ends A1, A2, A3, etc., arranged close together and alongside each other and second opposite ends B1, B2, B3, etc., arranged close together and alongside each other, i.e. a helical bundle En containing a desired number of wires.

After obtaining a number of spirals E1, E2, E3, etc., equal to the number of wires which the final bundle of wires must contain, the wire F is cut at T and (see FIG. 3C) the desired bundle of wires 6 is obtained by extension of the helical bundle/group En of individual spirals E1, E2, E3, etc., formed in succession in the manner described above, said final bundle 6 having a first end consisting of the group of first ends A1, A2, A3, etc., of the individual spirals E1, E2, E3, etc., and an opposite second end consisting of the group of second opposite ends B1, B2, B3, etc., of the same individual spirals E1, E2, E3, etc.

Description of the Second Embodiment of the Method—Feeding of a Bunch of Wires

In a second embodiment of the method according to the present invention it is possible to obtain a bundle containing a given number of wires, using a bunch of continuously fed wires F50, the number of wires contained in the final bundle being equal to a multiple of the quantity of wires which make up the individual bunch F50 fed.

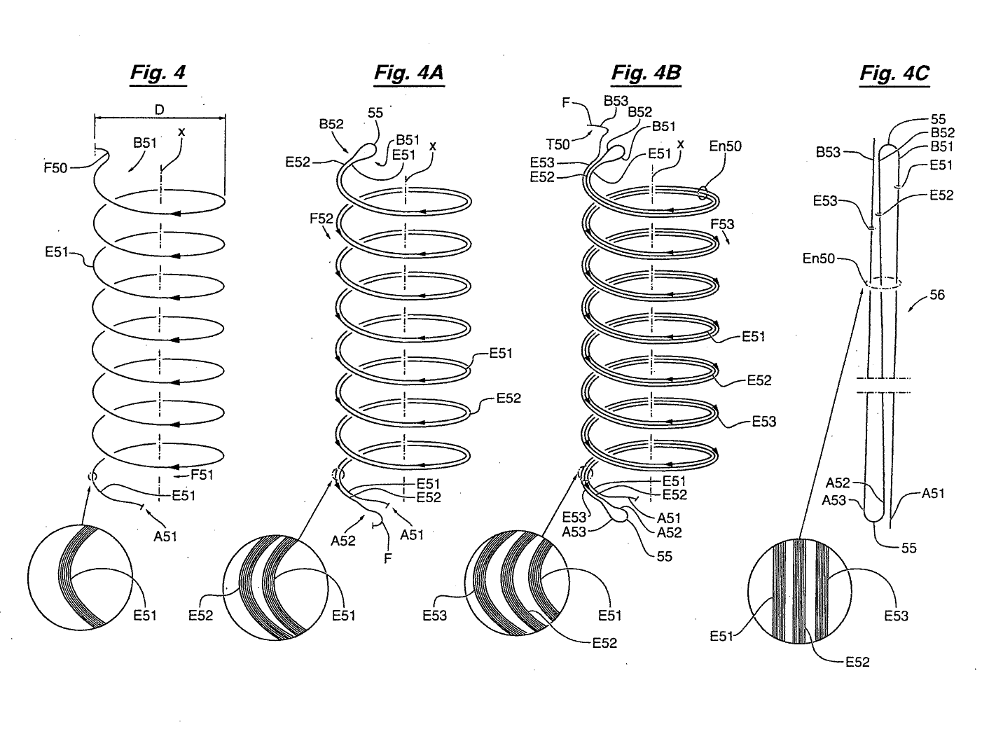

This second embodiment, shown in FIGS. 4, 4A, 4B, 4C, is substantially the same as that described above and therefore similar reference numbers are used and a shorter description given.

In this embodiment, using the bunch F50 (see FIG. 4) a first operation a) is performed, said operation involving winding the bunch F50 in the manner of a first multiple-turn spiral E51 which has a leading end A51 and a terminal end B51 (arrow F51).

Then (see FIG. 4A) a second operation b) is performed, said operation involving winding the same bunch F50 in a configuration having the form of an additional multiple-turn spiral E52 arranged alongside the preceding spiral E51, said additional spiral E52 having the leading end B52 arranged alongside the terminal end B51 of the preceding spiral E51 and the terminal end A52 arranged alongside the leading end A51 of the preceding spiral E51 (arrow F52).

Depending on the number of wires which the final bundle must contain (see FIG. 4B), a third operation c) is performed, said operation involving carrying out operation b) one or more times, a first repetition involving winding the same bunch F50 in a configuration having the form of an additional multiple-turn spiral E53 arranged alongside the preceding spirals E51, E52, said additional spiral E53 having the leading end A53 arranged alongside the terminal end A52 of the preceding spiral E52 and the terminal end B53 arranged alongside the leading end B52 of the preceding spiral E52.

With this operating method (see FIG. 4B again), repeating several times operation b), it is possible to obtain a group En50 of spirals E51, E52, E53, etc., which are arranged alongside each other, with the first ends A51, A52, A53, etc. arranged alongside each other and the second opposite ends B51, B52, B53, etc., arranged alongside each other, i.e. a helical bundle En50 containing a desired number of bunches F50 and therefore a desired number of wires as a multiple of the quantity of wires which make up each individual bunch F50.

After obtaining a desired number of spirals E51, E52, E53, etc., the bunch F50 is cut at T50 (see FIG. 4C) and the final bundle 56 of wires is obtained by extension of the helical bundle/group En50 of individual spirals E51, E52, E53, etc., said final bundle 56 having a first end A51, A52, A53 and an opposite second end B51, B52, B53, etc.

In this method also, preferably, when formation of a spiral following that of a preceding spiral is carried out, an eyelet 55 is formed with the bunch portion F50 which constitutes the reversal of the winding path and, more particularly, an eyelet 55 is formed between a terminal end of a spiral and a leading end of the following spiral B51-55-B52; A52-55-A53.

Description of Details Relating to the First and Second Embodiment of the Method

With reference to the two embodiments of the method described above, in order to vary the length of the final bundle 6 or 56 of wires which is to be obtained, it is possible to increase or reduce the number of turns of the spirals E1, E2, etc., E51, E52, etc., and also increase or reduce the diameter D, D50 of the spirals E1, E2, etc., E51, E52, etc.

Moreover, as may be understood more clearly below, the method described above may also envisage, before the aforementioned operations a), b), c), in the two embodiments of the abovementioned method, carrying out an operation intended to treat the wire F or treat the individual wires of the plurality of wires which make up the bunch F50, such as for example a treatment involving crimping of the wire F or the individual wires of the bunch F50, in order to obtain a bundle 6 or 15 of crimped wires.

Structural Description of the System

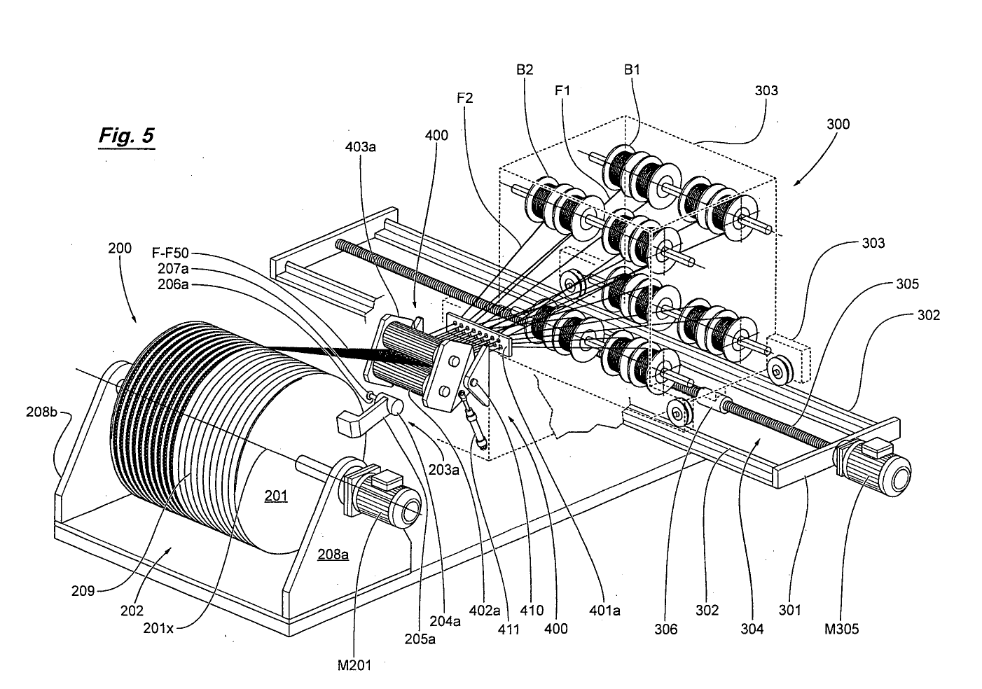

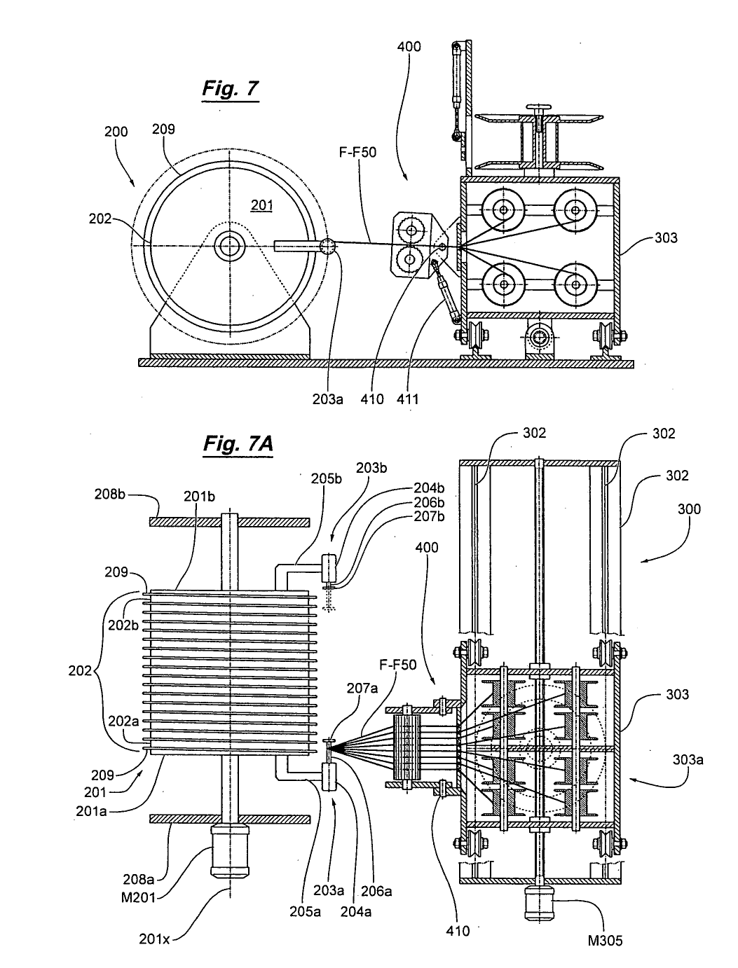

With reference to FIGS. 5, 7 and 7A, the system according to the present invention intended to implement the method described above comprises a rotating drum unit 200, a reel-holder unit 300 and a wire-feeding unit 400.

The drum unit 200 comprises a drum 201 designed to have, formed on its casing, a left-hand or right-hand multiple-turn helical groove 202 (in the example illustrated, left-hand) having a plurality of peaks 209 and two opposite ends 202a and 202b, said helical groove 202 having a transverse width and a depth able to contain a plurality of wires.

Retaining means 203a and 203b are arranged and supported in the vicinity of said two ends 202a and 202b, said means being suitable for retaining a wire F or a bunch F50 of wires in the manner and for the reasons which can be understood more clearly below.

Said retaining means 203a and 203b may assume various forms and, by way of example, may each comprise a respective actuator 204a and 204b, for example of the electromagnetic type, supported by a respective bracket 205a and 205b fixed to the respective ends 201a and 201b of the drum 201, each actuator 203a and 203b having a respective pin 206a and 206b having at its free end a respective head 207a and 207b in the form of a pawl and-or hook, each pin 206a and 206b being actuated so as to move, for example, along its own axis by means of the respective actuator 204a and 204b so as to be able to assume (see FIG. 7A) at least one retracted position, shown in continuous lines, and an extended position, shown in broken lines.

The drum 201 is supported by means of two shoulders 208a and 208b and is actuated so as to rotate, about its own axis, 201x, in the two opposite directions, by means of a servomotor M201, for example of the speed and phase control type (brushless motor). It is also possible to envisage other types of electric and/or electronic and/or mechanical drive systems.

The reel-holder unit 300 comprises a base 301 intended to support rails 302-302 which are directed parallel with respect to the axis 201x of rotation of the drum 201, said rails 302-302 slidably supporting a carriage/frame 303 which is actuated so as to move along said rails 302-302 by translation means 304 comprising, for example, a helical coupling system consisting of screw 305 and female thread 306, said screw 305 being supported rotationally by the base 302 and being actuated rotationally by means of a servomotor M305 and said female screw 306 being fixed to the carriage/frame 303.

The carriage/frame 303 supports a plurality of reels B1, B2, etc. (in the case illustrated sixteen reels), the respective wires F1, F2, etc. of which are conveyed towards a wire-feeding unit 400 which may assume various constructional forms depending on any operations which are to be carried out on the wires being fed, such as, for example, a wire-crimping unit.

With reference to FIG. 5, the wire-feeding unit 400 consists of a wire-crimping unit and comprises, from upstream downstream, a wire-aligning plate 401a, downstream of which crimping rollers 402a-403a are arranged, said rollers being intended to crimp the individual wires F1, F2, etc., so as to be able to feed towards the drum 201, alternatively, a single continuous crimped wire F or a continuous bunch F50 containing a given quantity of crimped wires.

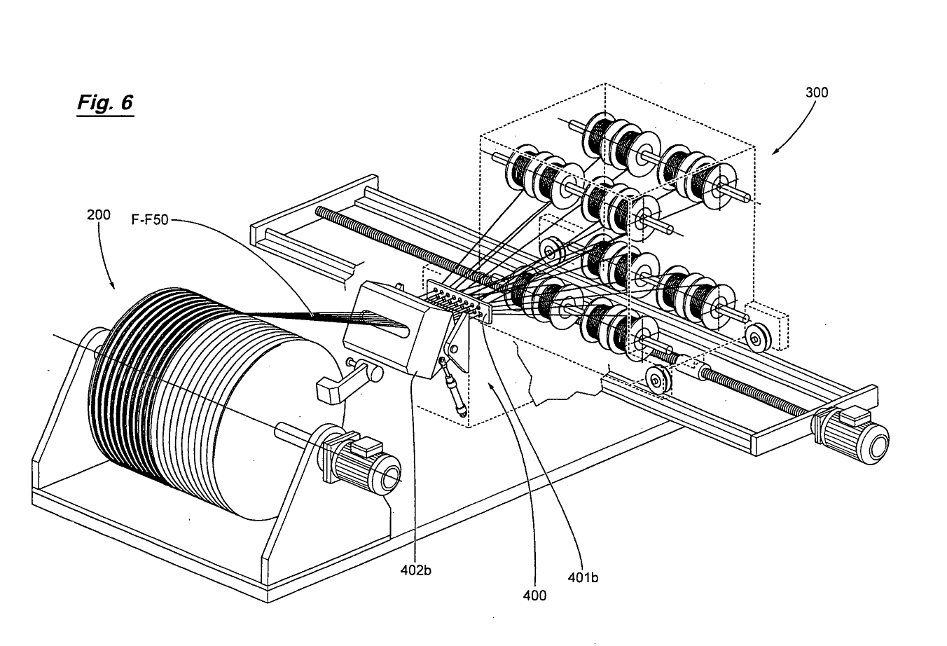

With reference to FIG. 6, said wire-feeding unit 400 comprises a wire-aligning plate 401b having, arranged downstream thereof, a header/funnel 402b intended to bunch together the wires so as to be able to feed towards the drum 201, alternatively, a single straight continuous wire F or a continuous bunch F50 containing a given quantity of straight wires.

The same wire-feeding unit 400, moreover, is able to oscillate in a plane radially with respect to the axis 201x of rotation of the drum 201, said oscillating movement being obtained by means of a pivoting system 410, the feeding unit 400 being actuated so to perform a vertical oscillating movement by means of an actuator 411.

The system described above also comprises electric and/or electronic and/or optoelectronic and/or mechanical means which are intended to manage the various actuating members and in particular are intended to manage the servomotor M201, the retaining means 203a and 203b, the servomotor M305, the actuator 411 as well as other operating means.

Moreover, although not shown, reel-braking friction means are also present, being mounted on the individual reels B1, B2, etc., and suitable for keeping the individual wires F1, F2, etc. taut during unwinding.

With the system described above, therefore, it is possible to feed towards the drum 201 a bunch of wires F50, of the type comprising crimped wires (FIG. 5), of the type comprising straight wires (FIG. 6) or of another type, said bunch F50 containing a desired number of single wires, and also, if desirable, feed towards the drum 201 a single wire F, of the crimped type, of the straight type (FIG. 6) or any other type and, moreover, convey towards the drum 201 a bunch of wires F50 of the type comprising a desired number of wires also different from each other, by arranging on the carriage/frame 303 reels containing wires which are different from each other.

Functional Description of the System

With reference to the structural description given above, the operating principle of the system is now described hereinbelow using illustrations where a bunch F50 of wires is used; however, said operating principle may be equally applied using a single wire F or a bunch of wires F50 of a different type.

With reference to FIGS. 7-7A, at the start of the operating cycle, the drum 201 is at a standstill, the carriage/frame 303 is at a standstill in a station 303a at the start of the travel path which envisages a substantial alignment between the end 202a of the groove 202 and the wire-feeding means 400, and the pin 206b is in its retracted position.

In this operative configuration it is envisaged actuating the retaining means 203a which are arranged in the vicinity of said first end 202a of the groove 202 so as to retain the wire F or the bunch F50 in the vicinity of said first end 202a.

More particularly, in the embodiment illustrated, it is envisaged arranging the pin 206a in its extended position, and the operator manually arranges the leading end of the wire F or the bunch F50 so that it is engaged on the pin 206a.

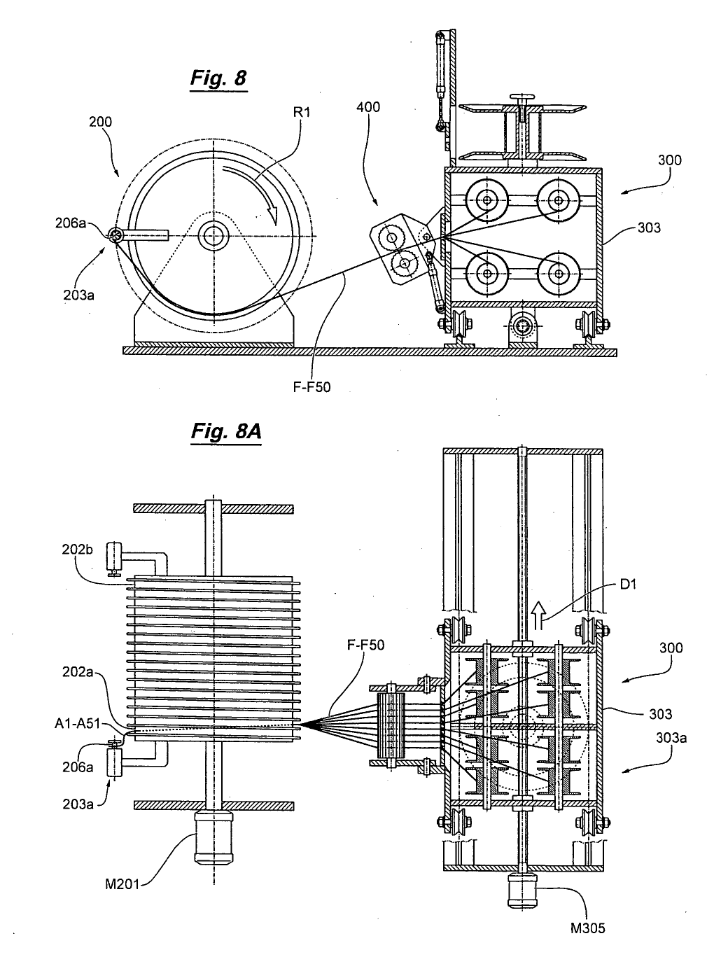

Then (see FIGS. 8-8A) it is envisaged actuating the servomotor M201 in a direction of rotation R1 so as to wind an initial portion of the wire F or the bunch F50 inside the leading end 202a of the groove 202, with the leading end A1-A51 arranged on the pin 206a, following a helical winding path 202a-202b directed towards the opposite end 202b of the same groove 202, effecting a rotation, for example, of about 180° for the drum 201, so as to then position the pin 206a in its retracted position, in order to avoid interference between said pin 206a and the wire F or the bunch F50 during the subsequent revolutions of the drum 201.

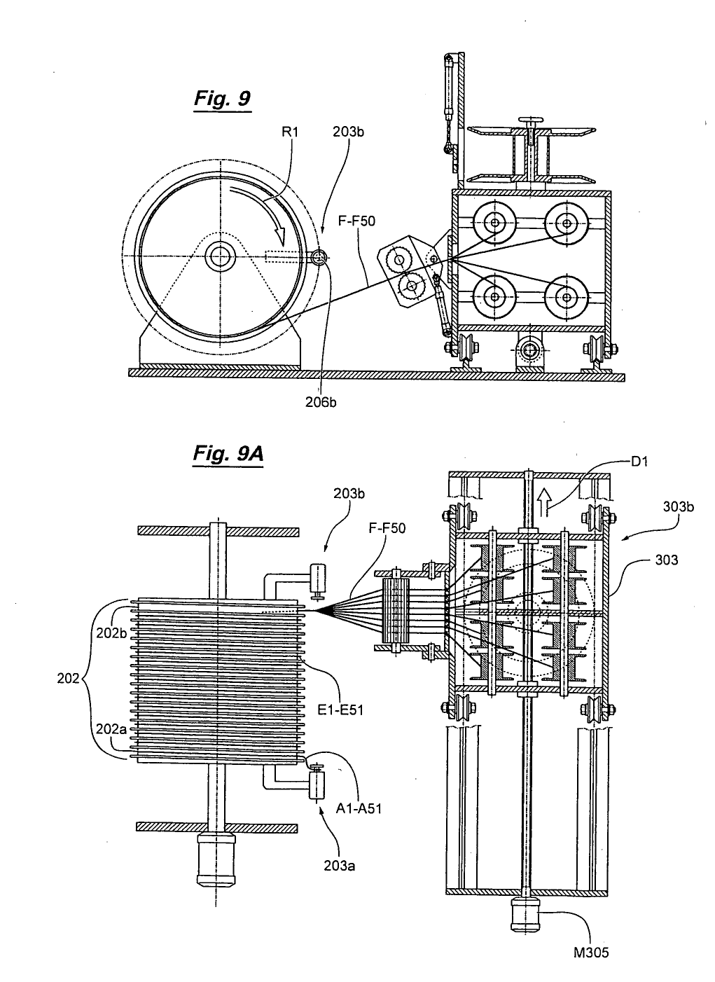

With reference to FIGS. 9-9A, the drum 201 has been further rotated in the direction R1 by means of the servomotor M201 and, at the same time, the carriage/frame 303 linearly displaced in the direction D1 towards the end 303b of the its linear travel path, so as to keep the point of tangency of the wire F or the bunch F50 with the drum/groove 201-202 substantially aligned with respect to the wire-feeding means 400 and thus deposit and wind the wire F or the bunch of wires F50 correctly inside and along said helical groove 202, following a path 202a-202b which starts from said first end 202a of the groove 202 and reaches said second end 202b of the same groove 202 and then form with the wire F, or with the bunch F50, a first spiral, previously described in connection with the method illustrated in FIGS. 3-3A-3B-3C and 4-4A-4B-4C, such as a spiral E1 or E51 having an end A1-A51 and B1-B51.

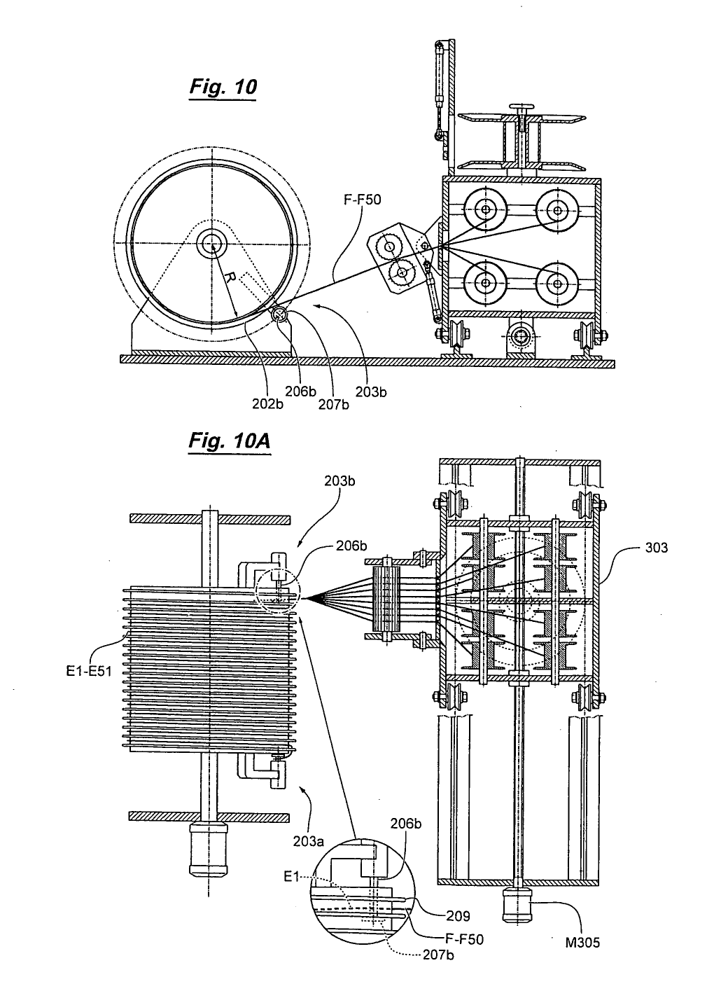

After obtaining the said first spiral, E1 or E51, it is envisaged stopping the movement of the drum 201 in a preferred rotor position, shown in FIGS. 10-10A, where the pin 206b is arranged underneath and close to the wire F or the bunch F50, i.e. outside the curve of the spiral E1 or E51 previously formed with a radius R and at the same time stop the translatory movement D1 of the carriage/frame 303.

In this operative configuration it is envisaged actuating the retaining means 203b arranged in the vicinity of said second end 202b of the groove 202 so as to retain the wire F or the bunch F50 in the vicinity of said second end 202b.

More particularly, in the case illustrated by way of example, it is envisaged arranging the pin 206b from its retracted position, shown in continuous lines, into its extended position, shown in broken lines, where the head 207b extends beyond the wire F or beyond the bunch F50, so as to retain the wire F or the bunch F50 in the vicinity of said end 202b following reversal in rotation of the drum 201 as can be better understood below.

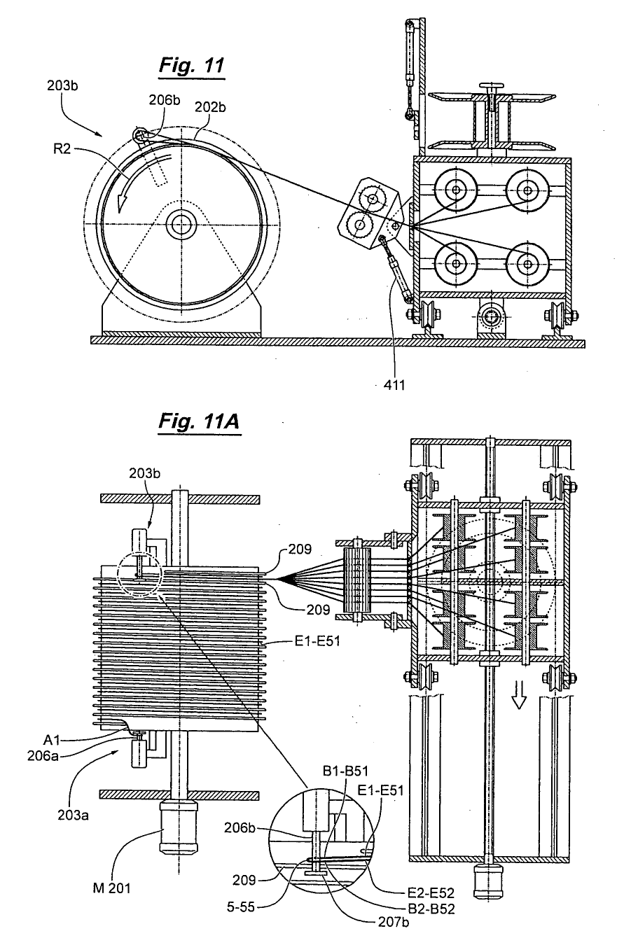

Then (see FIGS. 11-11A) it is envisaged actuating the actuator 411 so as to arrange the wire-feeding unit 400 in the raised position and actuate the servomotor M201, in the direction of rotation R2, through about 180° of rotation of the drum 201, and the extended pin 206b intercepts the wire F or the bunch F50, preventing unwinding of the spiral E1-51 already formed and, moreover, by means of said rotation R2 a second portion of wire F or portion of the bunch F50 is arranged inside the terminal portion 202b of the groove 202, alongside the preceding spiral E1-E51, following a winding path 202b-202a.

Therefore, at the end of the said operations, with reference also to the method according to FIGS. 3-3A-3B-3C and 4-4A-4B-4C (see FIG. 11A), the first spiral, E1 or E51, has the first end, A1 or A51, arranged in the vicinity of the pin 206a, and a second end, B1 or B51, arranged in the vicinity of the pin 206b and, moreover, the eyelet 5 or 55 is formed on the same pin 206b and the leading end B2-B52 of a second spiral E2-E52 is arranged thereon, as can be understood more clearly below.

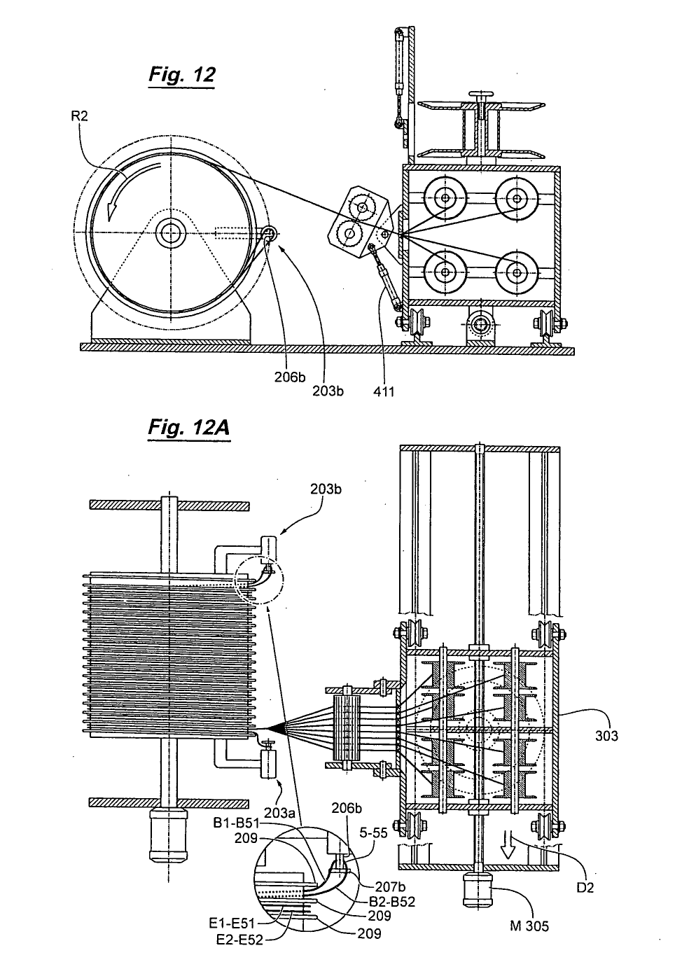

Then, it is envisaged positioning the pin 206b in its retracted position, in order to avoid interference between said pin 206b and the wire F or the bunch of wire F50 during the subsequent revolutions of the drum 201 and (see FIGS. 12-12A) it is envisaged also actuating the servo-motor M305 so as to displace linearly the carriage/frame 303 in the direction D2 so as to wind the wire F or the bunch F50 inside and along said helical groove 202 following a path 202b-202a which is the reverse of that described above and starts from said second end 202b and reaches said first end 202a in a manner substantially similar to the path described above, i.e. maintaining correct alignment between the wire-feeding unit 400 and the changing axial position which the point of tangency of the wire F or the bunch F50 assumes with respect to the helical groove 202 and therefore form a second spiral alongside the preceding spiral, implementing the method described above with reference to FIGS. 3-3A-3B-3C and 4-4A-4B-4C, said second spiral being indicated as spiral E2 or E52 arranged alongside the first spiral indicated as E1 or E51.

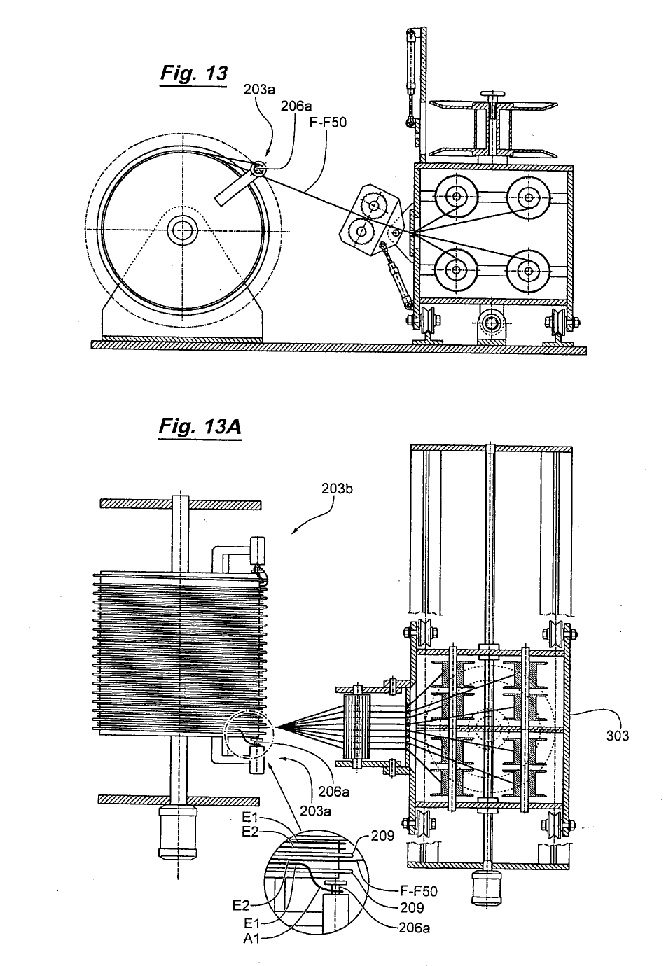

After obtaining the said second spiral, E2 or E52, the movement of the drum 201 is stopped in a preferred rotor position, shown in FIGS. 13-13A, where the pin 206a is arranged close to the wire F or the bunch F50 and outside the curve of the spiral E2 or E52 just formed and, at the same time, the translatory movement D2 of the carriage/frame 303 is stopped.

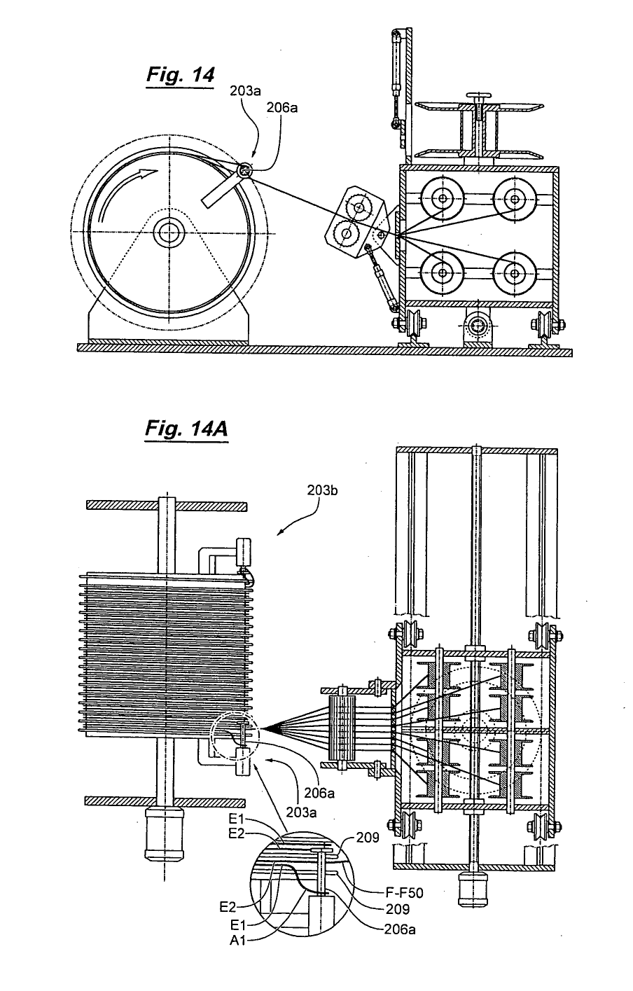

If it is desired to form an additional third spiral alongside the two spirals previously formed (see FIGS. 14-14A) the retaining means 203a arranged in the vicinity of said second end 202a of the groove 202 are actuated so as to retain the wire F or the bunch F50 in the vicinity of said second end 202a and, more particularly, the pin 206a is arranged in its extended position.

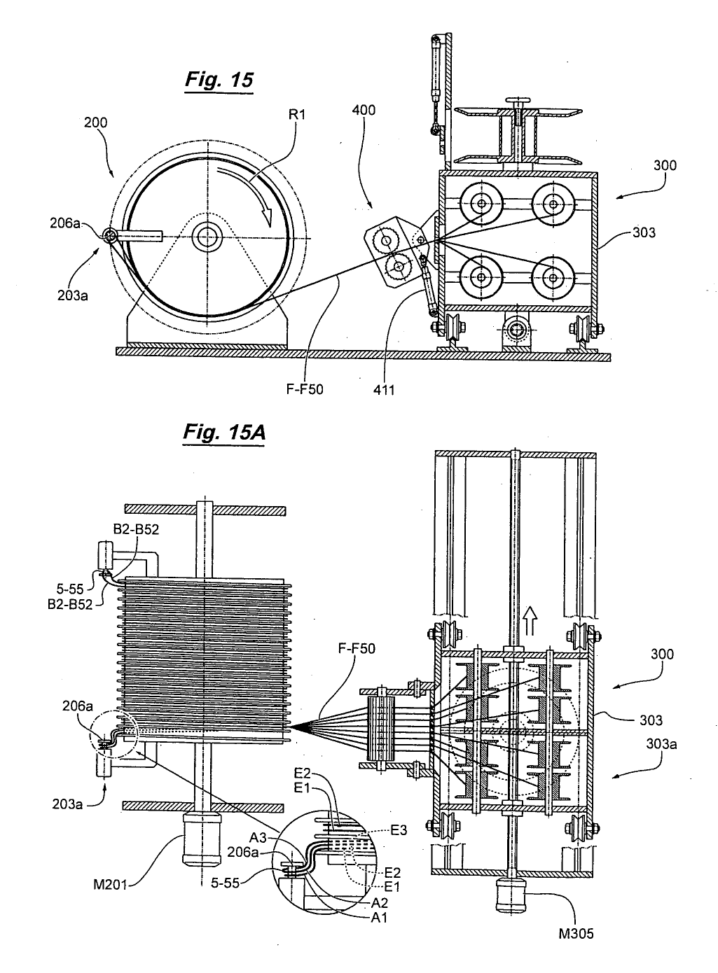

Then (see FIGS. 15-15A) it is envisaged actuating the actuator 411 so as to arrange the wire-feeding unit 400 in the lowered position, and actuating the servomotor M201 for a rotation through about 180° of the drum 201, so as to arrange, following a path 202a-202b, a portion of wire F or a portion of bunch F50 inside the terminal portion 202a of the groove 202 so as to then position the pin 206a in its retracted position, in order to avoid interference between said pin 206a and the wire F or the bunch of wire F50 during subsequent revolutions of the drum 201.

This latter operative configuration, shown in FIGS. 15-15A, is substantially the same as that shown in FIGS. 8-8A and therefore it is possible to repeat the operations described above until a desired quantity of spirals each composed of a wire F or a bunch F50 is formed, in succession, inside the helical groove 202, and, therefore, form inside said groove 202 a helical bundle containing a desired number of single wires.

After obtaining the desired number of wires inside the helical groove 202, the wire F or the bunch F50 downstream of the end 202a or 202b of the groove 202, for example in the vicinity of the pin 206a or 206b, is cut, obtaining, inside said groove 202, as described above in connection with the method illustrated in FIGS. 3-3A-3B-3C and 4-4A-4B-4C, a helical bundle, En or En50, containing a desired number of spirals, E1-E2-E3, etc., or E51-E52-E53, etc., which have first ends, A1-A2-A3, etc., or A51-A52-A53, etc., arranged alongside in the vicinity of the pin 206a, and opposite ends, B1-B2-B3, etc., or B51-B52-B53, etc., arranged alongside in the vicinity of the pin 206b.

Therefore, extracting in any manner said multiple-spiral helical bundle, En or En50, the desired bundle, 6 or 56 comprising a given quantity of wires is obtained.

Description of Reeling of the Bundle Obtained

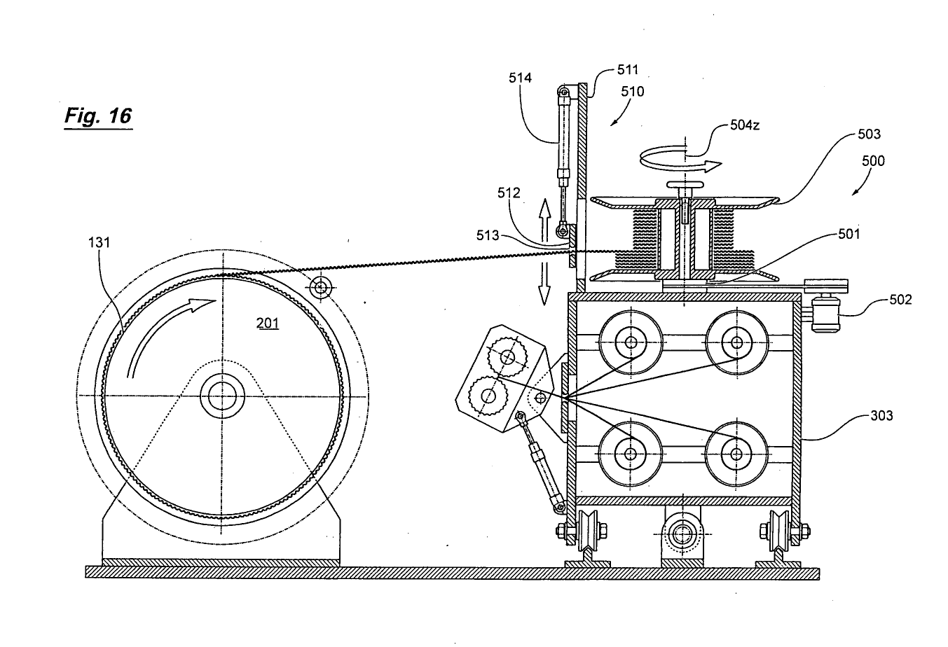

In this connection (see, for example, FIG. 16) it is possible to envisage an extractor device 500, supported by the carriage/frame 303 and intended to extract the helical bundle En or En50, said extractor device 500 being able to be positioned in the vicinity of one or other of the two ends 202a and 202b of said helical groove 202.

In the example illustrated in FIG. 16, the extractor device 500 is an extractor/reeling device arranged on the top of the carriage/frame 303 and intended to extract and wind up in reel form the helical bundle En or En50.

Said extractor/reeling device 500 substantially comprises a rotating reel support 501 which is actuated by means of a servomotor 502 and associated transmission, said rotating reel support 501 being intended to support a reel 503 with the associated axis 504z arranged vertically.

Moreover, between said reel 503 and the drum 201 there is provided a wire-guiding unit 510 supported by the carriage/frame 303 and comprising a support wall 511 fixed onto the carriage/frame 303 and intended to support in a vertically slidable manner a plate 512 having a through-hole 513, said plate being actuated so as to move vertically in both directions by means of an actuator 514.

With this extractor/reeling device 500, the operator manually passes one end A1-A2-A3, etc. or A51-A52-A53, etc., or B1-B2-B3, etc., or B51-B52-B53, etc., of the helical bundle En or En50 arranged inside the helical groove 202 through the hole 513 and then fixes it to the core of the reel 503 and then actuates the servomotor 502 and the actuator 514 so as to extract the helical bundle En or En50 from the helical groove 202 and wind it correctly onto the reel 503 by means of vertical translation of the plate/hole 512/513.

With reference to the description provided above it is obvious that with this invention it is possible to obtain a very long bundle of wires containing a desired and variable number of wires, the length of which will be equal to the circumference of the turns multiplied by the number of the same turns, thereby overcoming the problems described above in connection with the prior art.

The description of the method and the system is provided purely by way of a non-limiting example and therefore it is obvious that they may be subject to all those modifications and/or variations suggested by practice, utilization or employment thereof and in any case falling within the scope of the following claims which also form an integral part of the description given above.

1. A method of obtaining a bundle of wires containing a desired number of wires, which it comprises the steps of:
a)—winding the wire (F) in a configuration having the form of a first multiple-turn spiral (E1) having a leading end (A1) and a terminal end (B1);
b)—winding the wire (F) in a configuration having the form of an additional multiple-turn spiral (E2) arranged alongside the preceding spiral (E1) with a leading end (B2) of said additional spiral (E2) arranged alongside the terminal end (B1) of the preceding spiral (E1) and with a terminal end (A2) of said additional spiral (E2) arranged alongside the leading end (A1) of the preceding spiral (E1);
c)—performing the operation b) one or more times until a helical bundle (En) containing a desired number of individual successive multiple-turn spirals (E1, E2, E3, etc.) arranged alongside each other is obtained, the individual spirals (E1, E2, E3, etc.) having first ends (A1, A2, A3, etc.) arranged alongside each other and second opposite ends (B1, B2, B3, etc.) arranged alongside each other; and
d) obtaining the bundle of wires (6) containing a desired number of wires by extension of the helical bundle (En) of individual spirals (E1, E2, E3, etc.) formed in succession, said final bundle (6) having a first end consisting of the group of first ends (A1, A2, A3, etc.) of the individual spirals (E1, E2, E3, etc.) and an opposite second end consisting of the group of second opposite ends (B1, B2, B3, etc.) of the same individual spirals (E1, E2, E3, etc.).

2. The method according to claim 1, further comprising forming an eyelet (5) between the adjacent ends (B1-B2, A2-A3) of two successive spirals (E1-E2, E2-E3).

3. The method according to claim 1 wherein prior to the steps a), b) and c), a preliminary operation is carried out to treat the wire (F) supplied by the feeding reel.

4. The method according to claim 1, wherein prior to steps a), b) and c), an operation is carried out to crimp the wire (F) supplied by the feeding reel.

5. The method according to claim 1 wherein the number of turns of the winding spirals (E1, E2, En) is increased or reduced in order to vary the length of the final bundle (6) of wires which is to be obtained.

6. The method according to claim 1, wherein the diameter (D) of the turns of the winding spirals (E1, E2, En) is increased or reduced in order to vary the length of the final bundle (6, 16) of wires which is to be obtained.

7. The method of obtaining a bundle of wires containing a desired number of wires, in which a bunch (F50) of wires is used, comprising the steps of:
a)—winding the bunch (F50) in a configuration having the form of a first multiple-turn spiral (E51) having a leading end (A51) and a terminal end (B51);
b)—winding the bunch (F50) in a configuration having the form of an additional multiple-turn spiral (E52) arranged alongside the preceding spiral (E51) with a leading end (B52) of said additional spiral (E52) arranged alongside the terminal end (B51) of the preceding spiral (E51) and with a terminal end (A52) of said additional spiral (E52) arranged alongside the leading end (A51) of the preceding spiral (E51);
c)—performing the operation b) one or more times until a helical bundle (En50) containing a desired number of individual successive multiple-turn spirals (E51, E52, E53, etc.) formed in succession and arranged alongside each other is obtained, the individual spirals (E51, E52, E53, etc.) having first ends (A51, A52, A53, etc.) arranged alongside each other and second opposite ends (B51, B52, B53, etc.) arranged alongside each other; and
d) obtaining a final bundle (56) of wires by extension of the helical bundle (En50) of individual spirals (E51, E52, E53, etc.) formed in succession, said final bundle (56) having a first end consisting of the group of first ends (A51, A52, A53, etc.) of the individual spirals (E51, E52, E53, etc.) and a second opposite end consisting of the group of second opposite ends (B51, B52, B53, etc.) of the same individual spirals (E51, E52, E53, etc.).

8. The method of according to claim 7, which comprises forming of an eyelet (55) between the adjacent ends (B51-B52, A52-A53) of two successive spirals (E51-E52, E52-E53).

9. The method of according to claim 7, prior to steps a), b) and c), a preliminary operation intended to treat the wires of the bunch (F50) supplied by the feeding reels is carried out.

10. The method of according to claim 7, prior to steps a), b) and c), the wires of the bunch (F50) supplied by the feeding reels are crimped.

11. The method of according to claim 7, wherein the number of turns of the winding spirals (E51, E52, En50) is increased or reduced in order to vary the length of the final bundle (16) of wires which is to be obtained.

12. The method of according to claim 7, the diameter (D) of the turns of the winding spirals (E51, E52, En50) is increased or reduced in order to vary the length of the final bundle (16) of wires which is to be obtained.

13. A system for obtaining a bundle of wires containing a desired number of wires, in which a wire (F) or a bunch (F50) of wires is used, which comprises a drum (201) having, formed on its casing, a multiple-turn helical groove (202) comprising a first end (202a) and a second end (202b); said helical groove (202) has a width such as to contain a plurality of wires (F) or a plurality of bunches (F50); and retaining means (203a, 203b) are provided for retaining the wire (F) or the bunch of wires (F50) in the vicinity of at least one end (202a, 202b) of said helical groove (202).

14. The system according to claim 13, characterized in that it comprises the following operative steps:
a)—arranging the wire (F) or the bunch (F50) in the vicinity of a first end (202a) of said helical groove (202);
b)—rotating the drum (201) in a first direction (R1) in order to wind the wire (F) or the bunch (F50) inside and along said helical groove (202) following a path (202a-202b) which starts from said first end (202a) and reaches said second end (202b), so as to form a first multiple-turn spiral (E1; E51);
c)—actuating the retaining means (203b) arranged in the vicinity of said second end (202b) of the groove (202) so as to retain the wire (F) or the bunch (F50) in the vicinity of said second end (202b);
d)—actuating rotation of the drum in a second direction (R2), opposite to the preceding direction (R1), in order to wind the wire (F) or the bunch (F50) inside and along said helical groove (202) following a path (202b-202a) which starts from said second end (202b) and reaches said first end (202a), so as to form a second multiple-turn spiral (E2; E52) arranged alongside the said first spiral (E1; E51).

15. The system according to claim 13, characterized in that wherein first retaining means (203a) are provided for retaining the wire (F) or the bunch of wires (F50) in the vicinity of said first end (202a) of said helical groove (202) and second retaining means (203b) are provided for retaining the wire (F) or the bunch of wires (F50) in the vicinity of said second end (202b) of said helical groove (202).

16. The system according to claim 14, wherein it comprises, after the operation step d), the following additional operations steps:
e)—actuating the retaining means (203a) arranged in the vicinity of said first end (202a) of the helical groove (202) so as to retain the wire (F) or the bunch (F50) in the vicinity of said first end (202a);
f)—perform the previous operating step a) in order to form an additional multiple-turn spiral (E3; E53) arranged alongside the spirals (E1-E2; E51-E52) previously formed.

17. The system according to claim 16, wherein steps a), b), c), d) e), f) described above are performed until a desired number of spirals (E1-E2-E3, etc.; E51-E52-E53, etc.) is obtained inside the helical groove (202).

18. The system according to claim 13, wherein said retaining means (203a, 203b) are supported in the vicinity of the ends (201a, 201b) of the drum and comprise an actuating device (204a, 204b) intended to move a retaining pin (206a-207a, 206b-207b) in the form of a hook and in that said pin (206a-207a, 206b-207b) is intended to assume a first operating position, where it interferes with the flow of wire (F) or with the flow of the bunch (F50), and a non-operating position, where it does not interfere with the flow of wire (F) or with the flow of the bunch (F50).

19. The system according to claim 13, wherein the wire (F) or the bunch (F50) is fed by means of a wire-feeding unit (400); in that said wire-feeding unit (400) is operated so as to perform a translatory movement along a path directed parallel with the axis (201x) of rotation of the drum (201) in order to keep the flow of wire (F) or flow of the bunch (F50) aligned with the point of tangency and insertion of the wire (F) or the bunch (F50) inside the helical groove (202); and in that during the operations involving winding of the wire (F) or the bunch (F50) inside the helical groove (202), said wire-feeding unit (400) is displaced along said path in such a way as to keep said wire-feeding unit (400) aligned with the point of tangency of insertion of the wire (F) or the bunch (F50) inside the said helical groove (202).

20. The system according to claim 19, wherein said wire-feeding unit (400) oscillates in a plane arranged radially with respect to the axis of rotation (201x) of the drum (201).

21. The system according to claim 19, wherein said feeding unit (400) is a device (402a, 403a) intended to crimp a wire (F) or a plurality of wires which make up the bunch (F50).

22. The system according to claim 19, wherein said feeding unit (400) is supported by means of a carriage/frame (303) intended to support also one or more wire-feeding reels (B1, B2, etc.) and said carriage/frame (303) is operated so as to be displaced along a path arranged parallel with the axis (201x) of rotation of the drum (201).

23. The system according to claim 22, wherein said carriage/frame (303) is slidably supported by means of the guides (302, 302) supported by the base (301) and in that said carriage/frame (303) is operated so as to be displaced by means of actuating means (304).

24. The system according to claim 22, wherein said carriage/frame (303) also supports an extractor device (500) intended to extract the helical bundle (En; En50).

25. The system according to claim 24, wherein said extractor device (500) is an extractor/reeling device intended to extract and wind up in reel form the helical bundle (En; En50).

26. The system according to claim 24, wherein said extractor/reeling device (500) comprises a rotating reel support (501) and a wire-guiding unit (510).

27. A bundle of wire containing a given number of wires obtained by the method of claim 1.

28. A bundle of wire containing a given number of wires obtained by the method of claim 7.
